(19) United States
(12) Patent Application Publication
(10) Pub. No.: US 2018/0345881 A1
(43) Pub. Date: Dec. 6, 2018

(54) RECESSED AND RAISED SURFACE FEATURES FOR NOISE REDUCTION

(71) Applicant: FORD GLOBAL TECHNOLOGIES, LLC, Dearborn, MI (US)

(72) Inventors: Sridhar Santi BOYINA, Canton, MI (US); Ravi Teja KATRAGADDA, Auburn Hills, MI (US); Jamie MARCH, Wyandotte, MI (US); John Michael MCGUCKIN, Ann Arbor, MI (US); Michael J. KOZAK, Canton, MI (US)

(21) Appl. No.: 15/615,177

(22) Filed: Jun. 6, 2017

(51) Int. Cl. B60R 13/08; B60R 13/02; B21D 22/02; B64C 1/40; B64C 1/06

(52) U.S. Cl. CPC B60R 13/0838; B60R 13/0256; B21D 22/02; B60R 13/08; B64C 1/066; B60R 13/02; B64C 1/40

(57) ABSTRACT

A panel of the passenger compartment of a vehicle, such as a dash panel, and a method of making a panel with reduced radiated panel noise. A panels of the passenger compartment of a vehicle have committed regions that are formed to receive assembled components, welds and fasteners. Interstitial regions are available between the committed regions that are formed to include a plurality of raised surface features and a plurality of recessed surface features for reducing radiated panel noise. A method is disclosed for forming a plurality of raised surface features and a plurality of recessed surface features in the interstitial regions that increase the stiffness of the interstitial regions to reduce radiated panel noise.

### TECHNICAL FIELD

This disclosure relates to the concept of forming a plurality of raised and recessed regular geometric surface features on internal metal panels forming parts of the passenger compartment of a vehicle to reduce radiated panel noise.

### BACKGROUND

Airborne and structural borne noises are a problem inside the passenger compartment of a vehicle. Noise inside the passenger compartment may be measured in terms of speech interference levels because higher noise levels interfere with speech inside the passenger compartment. The metal panels forming the passenger compartment that are not “Class A” surfaces (surfaces visible to occupants) include dash panels, wheel housings, floor pans, kick-up panels, cowl side panels, and the like. Computer Aided Engineering (CAE) software may be used to evaluate the noise transfer properties of such panels.

Conventional approaches to reducing noise levels include attaching sound dampening materials such as fibrous mats, and applying mastics to metal panels forming the passenger compartment. For example, the dash panel of a vehicle separates the engine and passenger compartment and is generally provided with sound dampening materials to reduce noise transfer from the engine and transmission of the vehicle. Other panels forming the passenger compartment may include sound dampening materials to reduce road and tire noise.

While noise can be reduced by sound dampening materials, such materials add weight to the vehicle that is undesirable in view of weight reduction efforts required to improve fuel economy. Adding sound dampening materials also adds to the cost of a vehicle for the sound dampening materials and added assembly operations. In addition, adding sound dampening materials is limited by the packaging space available.

A large number of components are welded or fastened together to assemble the passenger compartment of a vehicle. Many components are assembled to the inside and outer portions of the passenger compartment that must fit into confined areas. Clearances are specified around weld locations, fastener locations, brackets and between mating parts that must be maintained to avoid “squeaks and rattles.”

This disclosure is directed to solving the above problems and other problems as summarized below.

### SUMMARY

According to one aspect of this disclosure, a dash panel member is disclosed that includes a panel disposed between the passenger compartment and an engine compartment of a vehicle. The panel has committed regions that are formed to receive assembled components, welds and fasteners. Interstitial regions are located between the committed regions. The interstitial regions are formed to include a plurality of raised surface features and a plurality of recessed surface features that are formed integrally on the panel for reducing radiated panel noise.

The raised surface features and recessed surface features are partially spherical domes on a first side of the panel. The raised and recessed surface features may be circular with recessed domes on a first side of the panel and protruding domes on a second side of the panel.

The raised and recessed surface features may include a recessed circular fillet extending between a base wall of the panel and a recessed central portion on a first side and a raised circular fillet extending between the base wall and a raised central portion on the first side of the panel.

The raised and recessed surface features may include a recessed polygonal fillet extending between a base wall of the panel and a recessed central portion on a first side and a raised polygonal fillet extending between the base wall and a raised central portion on the first side of the panel.

The surface features may be between 25 and 40 mm across and have a depth of between 7 and 10 mm.

A first group of the surface features may be provided in a first size and a second group of the surface features may be provided in a second size that is smaller than the first group of surface features.

According to another aspect of this disclosure, a panel is provided that defines a portion of the passenger compartment of a vehicle. The panel includes design dedicated regions that are adapted to receive assembled components, welds and fasteners, and interstitial regions between the design dedicated regions. The interstitial regions include a plurality of raised surface features and a plurality of recessed surface features that increase the stiffness of the interstitial regions to reduce radiated panel noise.

The panel may include but are not limited to a compartment pan, a dash panel, a wheel housing, a kick-up panel, a pillar inner panel, or a cowl panel.

According to another aspect of this disclosure, a method of reducing radiated panel noise is disclosed that comprises selecting a sheet metal blank and forming the blank in a die to include design dedicated regions that are adapted to receive assembled components, welds and fasteners, and interstitial regions between the design dedicated regions. A plurality of raised surface features and a plurality of recessed surface features are formed in the interstitial regions that increase the stiffness of the interstitial regions to reduce radiated panel noise.

The method may further comprise designing a vehicle panel to receive assembled components in accessory dedicated areas and fasteners in fastener dedicated areas. Interstitial areas are then identified that are spaced from the accessory dedicated areas and the fastener dedicated areas. The vehicle panel is then designed to include raised regular geometric shaped surface features and recessed regular geometric shaped surfaces in the interstitial areas that are spaced from the accessory dedicated areas and the fastener dedicated areas.

The method may further comprise forming the regular geometric surface features that may be raised and recessed circular domes, polygonal raised areas and polygonal recessed areas, or a first set of regular geometric surface features that are a first size and a second set of the surface features that are provided in a second size that is smaller than the first size.

The above aspects of this disclosure and other aspects will be described below with reference to the attached drawings.

### BRIEF DESCRIPTION OF THE DRAWINGS

FIG. 1 is a perspective view of a vehicle with a dash panel including a plurality of raised and recessed dome-shaped surface features in interstitial areas of the dash panel shown in phantom lines.

FIG. 2 is a rear elevation view of the dash panel shown in FIG. 1 with the raised and recessed dome-shaped surface features in interstitial areas of the dash panel shown in phantom lines behind other interior trim components.

FIG. 3 is a rear elevation view of the dash panel shown in FIG. 1 with the raised and recessed dome-shaped surface features in interstitial areas of the dash panel.

FIG. 4 is a fragmentary perspective view of a plurality of raised and recessed dome-shaped surface features in interstitial areas of the dash panel.

FIG. 5 is a cross-section view taken along the line 5-5 in FIG. 4.

FIG. 6 is a fragmentary elevation view of raised and recessed rectilinear surface features.

FIG. 7 is a cross-section view taken along the line 7-7 in FIG. 6.

FIG. 8 is a fragmentary elevation view of raised and recessed hexagonal surface features.

FIG. 9 is a cross-section view taken along the line 9-9 in FIG. 8.

FIG. 10 is a fragmentary elevation view of raised and recessed rectilinear surface features of two different sizes.

FIG. 11 is a cross-section view taken along the line 11-11 in FIG. 10.

FIG. 12 is a cross-section view of another embodiment of a plurality of raised and recessed partially spherical dome-shaped surface features.

### DETAILED DESCRIPTION

The illustrated embodiments are disclosed with references being made to the drawings. However, it is to be understood that the disclosed embodiments are intended to be merely examples that may be embodied in various and alternative forms. The figures are not necessarily to scale and some features may be exaggerated or minimized to show component details. The specific structural and functional details disclosed are not to be interpreted as limiting, but as a representative basis for teaching one skilled in the art how to practice the disclosed concepts.

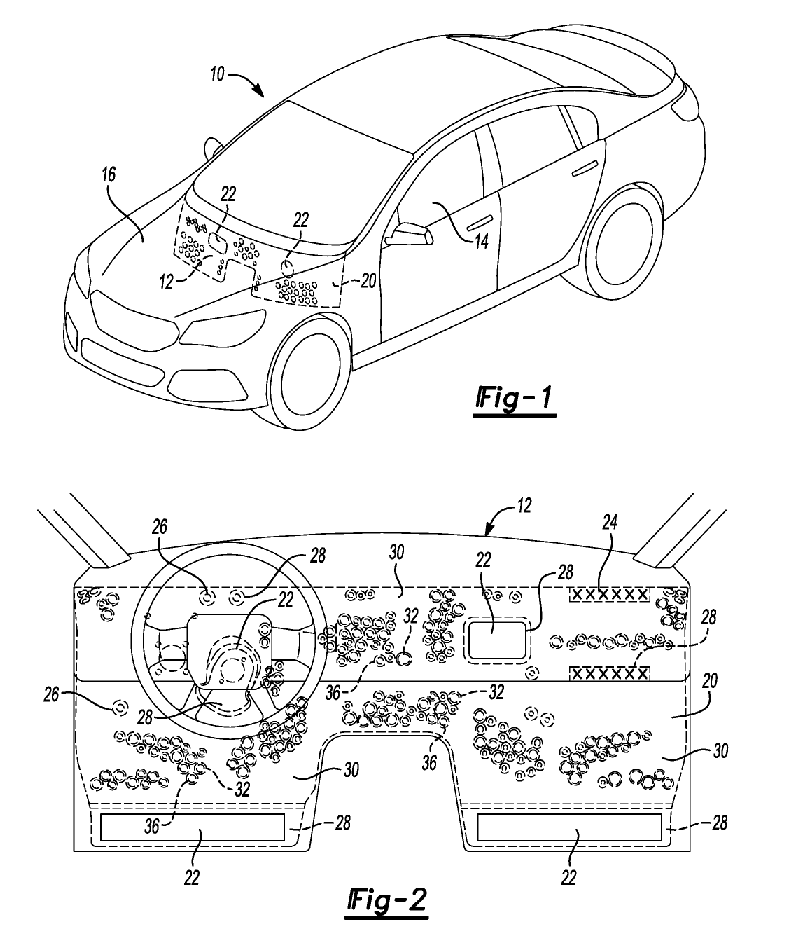

Referring to FIG. 1, a vehicle 10 is illustrated that includes a dash panel assembly, shown in phantom lines, that is disposed between a passenger compartment 14 and an engine compartment 18. Assembled components 22 such as a steering wheel column, air bag containers, entertainment systems, HVAC ducts and vents, and the like are also shown in phantom as they are assembled to the dash panel 20.

Referring to FIG. 2, the dash panel assembly 12 is shown in an elevation view taken from inside the passenger compartment 14 (shown in FIG. 1) with the dash panel in phantom because it is concealed by interior trim parts. Assembled components 22, welds 24 and fasteners 26 are shown that are attached to committed regions 28 of the dash panel 20. The committed regions may also be referred to as dedicated regions. The term “committed regions” as used herein refers to the portions of the dash panel where assembled components 22, welds 24 and fasteners 26 are attached and also the required clearance areas around the assembled components 22, welds 24 and fasteners 26. Areas between the committed regions are referred to herein as interstitial regions 30. The interstitial regions in general are flat or smoothly curved areas that may be troublesome panel noise radiating areas, otherwise known as noisy locations.

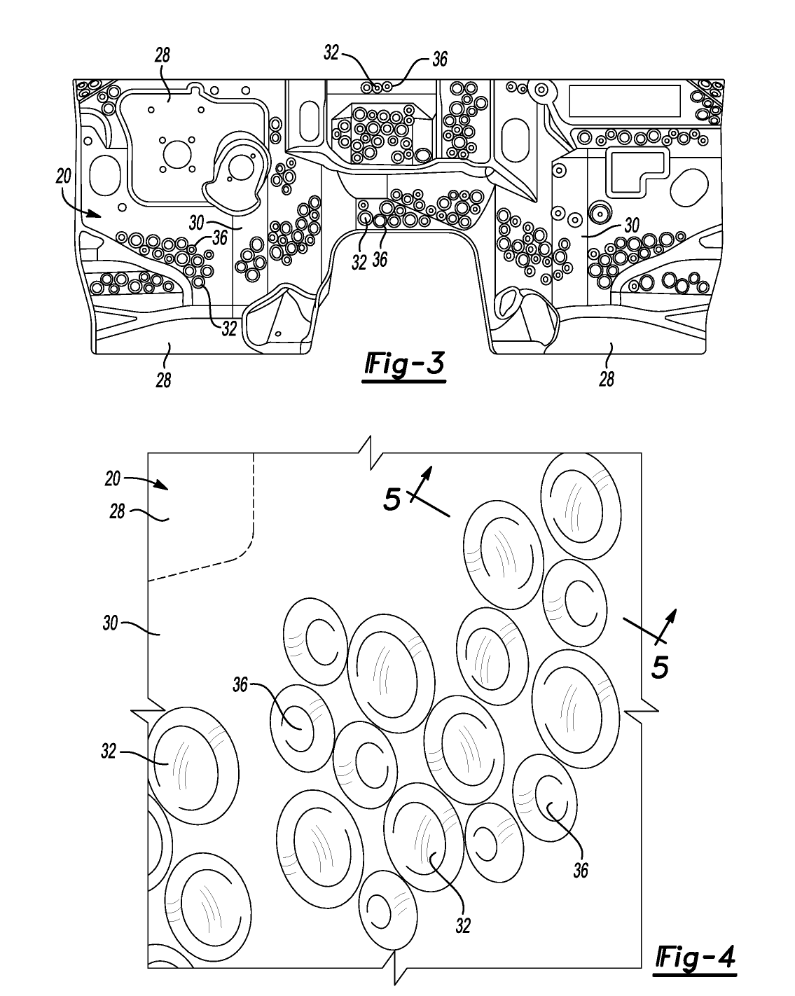

Referring to FIG. 3, raised surface features 32 and recessed surface features 36 are shown to be formed on the dash panel 20 in the interstitial regions 30. The raised surface features 32 and recessed surface features 36 increase the stiffness of the interstitial regions 30. The raised surface features 32 and recessed surface features 36 are regular geometric shapes that may be formed in the dash panel 20 stamping process in locations of the interstitial regions 30 as needed for reducing radiated panel noise. The dash panel 20 has a first side 38, or inside, facing the passenger compartment (shown in FIG. 1) and second side 39, or outside, that faces the engine compartment (shown in FIG. 1). References to the surface features being raised or recessed are relative to the inside surface. The same surface features on the outside surface are oppositely oriented because they are stamped into the dash panel 20.

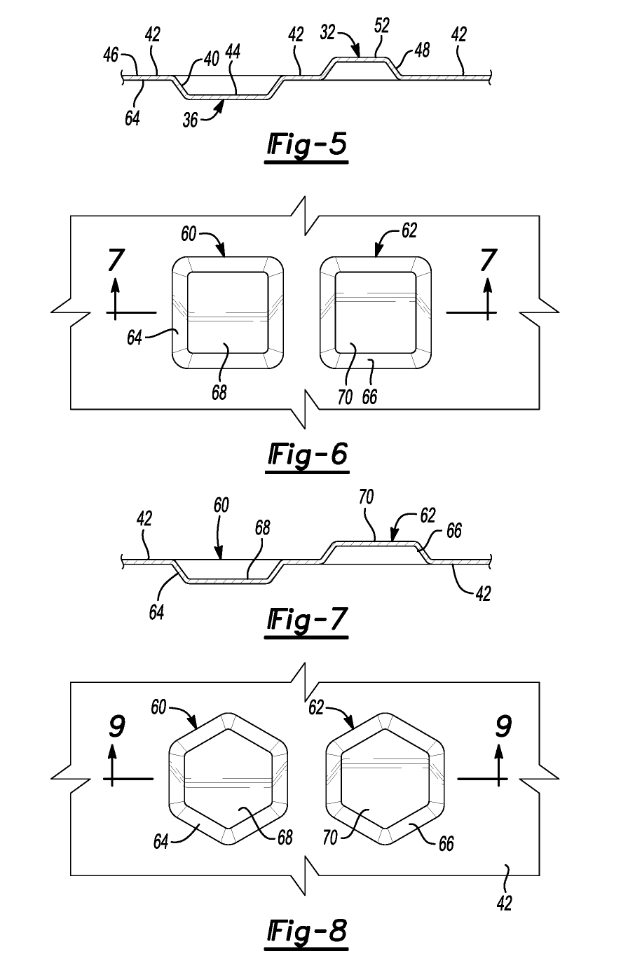

Referring to FIGS. 4 and 5, the dash panel 20 is partially illustrated to show the raised surface features 32 and recessed surface features 36 in greater detail. The recessed surface features 36 include a recessed circular fillet 40 that extends from a base wall 42 of the dash panel 20 to a circular recessed central portion 44. The recessed surface feature 36 may also be formed entirely by the recessed circular fillet 40 to form a partially spherical dome, as shown in FIG. 12. The raised surface features 32 include a raised circular fillet 48 extends from a base wall 42 of the dash panel 20 to a circular raised central portion 44. The raised surface feature 32 may also be formed entirely by the raised circular fillet 48 to form a partially spherical dome, as shown in FIG. 12.

Referring to FIGS. 6 and 7, an alternative embodiment is illustrated of a set of regular polygonal surface features. A recessed polygonal surface feature 60 (a square) and a raised square polygonal surface feature 62 (a square) are shown being provided on a base wall 42. The recessed surface feature 60 has a recessed fillet 64 and the raised surface feature 62 has a raised fillet 66. The recessed fillet extends from the base wall 42 to a recessed central portion 68. The raised fillet 64 extends from the base wall 42 to a raised central portion 70.

Referring to FIGS. 8 and 9, an alternative embodiment is illustrated of a recessed polygonal surface feature 60 (a hexagon) and a raised square polygonal surface feature 62 (a hexagon) provided on a base wall 42. The recessed surface feature 60 has a recessed fillet 64 and the raised surface feature 62 has a raised fillet 66. The recessed fillet 64 extends from the base wall 42 to a recessed central portion 68. The raised fillet 66 extends from the base wall 42 to a raised central portion 70.

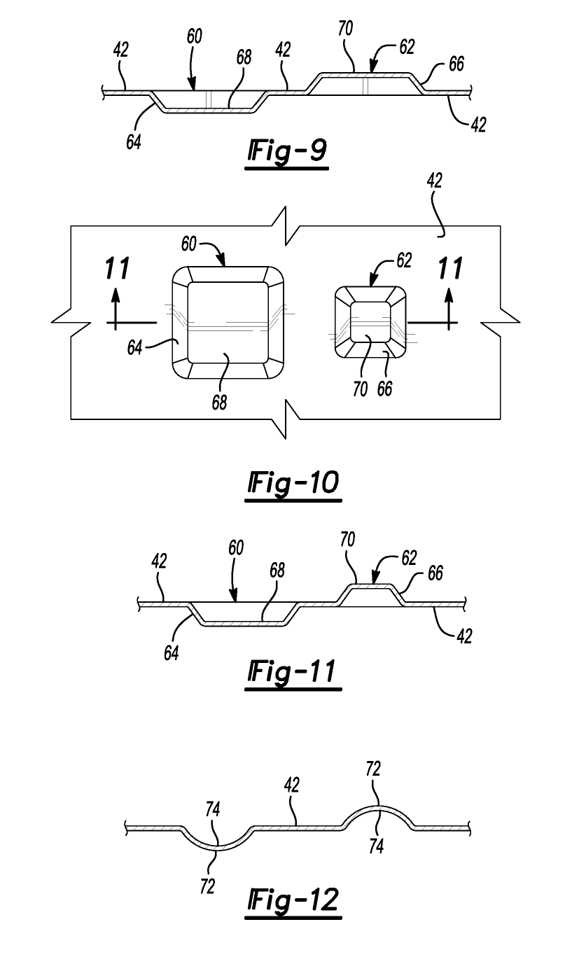

Referring to FIGS. 10 and 11, another variation is shown that includes providing different sizes of regular geometric surface features. The surface features 60 and 62 in this view are squares provided on a base wall 42. The larger, recessed surface feature 60 has a recessed fillet 64 and the smaller, raised surface feature 62 has a raised fillet. The recessed fillet 64 extends from the base wall 42 to a recessed central portion 68. The raised fillet 66 extends from the base wall 42 to a raised central portion 70. The concept of providing different sized surface features also applies to other polygonal, circular or dome-shaped surface features and may be utilized to increase the number of surface features provided in interstitial regions of the panel.

Referring to FIG. 12, an additional example is provided wherein the raised surface features and recessed surface features are partially spherical domes that are provided on a first side of the panel. A convex dome 72 and a concave dome 74 are provided on the base wall 42 relative to the first side of the wall. On the second side of the wall, the convex domes are concave and the concave domes are convex relative to the second side.

While the specific examples described above with reference to the drawings are of embodiments that have the same shape on a given panel it is also possible to mix any type of surface feature with other shapes of surface features. Mixing different shapes of surface features may facilitate fitting more surface features in a smaller interstitial region and may also modify the extent of panel radiated noise.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A dash panel assembly comprising:
a panel disposed between a passenger compartment and an engine compartment of a vehicle, the panel having committed regions that are formed to receive assembled components, welds and fasteners, wherein interstitial regions between the committed regions, wherein the interstitial regions are formed to include a plurality of raised surface features and a plurality of recessed surface features for reducing radiated panel noise.

2. The dash panel assembly of claim 1 wherein the raised surface features and recessed surface features are partially spherical domes on a first side of the panel.

3. The dash panel assembly of claim 1 wherein each of the raised and recessed surface features are circular with recessed domes on a first side of the panel and protruding domes on a second side of the panel.

4. The dash panel assembly of claim 1 wherein the raised and recessed surface features include a circular fillet extending between a base wall of the panel and a recessed central portion on a first side and a raised circular fillet extending between the base wall and a raised central portion on the first side of the panel.

5. The dash panel assembly of claim 1 wherein the raised and recessed surface features include a recessed polygonal fillet extending between a base wall of the panel and a recessed central portion on a first side and a raised polygonal fillet extending between the base wall and a raised central portion on the first side of the panel.

6. The dash panel assembly of claim 1 wherein the surface features are between 25 and 40 mm across and have a depth of between 7 and 10 mm.

7. The dash panel assembly of claim 1 wherein a first group of the surface features are provided in a first size and a second group of the surface features are provided in a second size that is smaller than the first group of the surface features.

8. A panel that defines a portion of a passenger compartment of a vehicle including design dedicated regions that are adapted to receive assembled components, welds and fasteners, and interstitial regions between the design dedicated regions, wherein the interstitial regions include a plurality of raised surface features and a plurality of recessed surface features that increase stiffness of the interstitial regions to reduce radiated panel noise.

9. The panel of claim 8 wherein the raised and recessed surface features are dome-shaped with recessed domes and raised domes on a first side of the panel.

10. The panel of claim 8 wherein each of the raised and recessed surface features are circular with recessed domes on a first side of the panel and protruding domes on a second side of the panel.

11. The panel of claim 8 wherein the raised and recessed surface features include a circular fillet extending between a base wall of the panel and a recessed central portion on a first side and a raised circular fillet extending between the base wall and a raised central portion on the first side of the panel.

12. The panel of claim 8 wherein the raised and recessed surface features include a recessed polygonal fillet extending between a base wall of the panel and a recessed central portion on a first side and a raised polygonal fillet extending between the base wall and a raised central portion on the first side of the panel.

13. The panel of claim 8 wherein the surface features are between 25 and 40 mm across and have a depth of between 7 and 10 mm.

14. The panel of claim 8 wherein a first group of the surface features are provided in a first size and a second group of the surface features are provided in a second size that is smaller than the first group of the surface features.

15. A method of reducing radiated panel noise comprising:
selecting a sheet metal blank:
forming the blank in a die to include design dedicated regions that are adapted to receive assembled components, welds and fasteners, and interstitial regions between the design dedicated regions; and
forming a plurality of raised surface features and a plurality of recessed surface features in the interstitial regions that increase stiffness of the interstitial regions to reduce radiated panel noise.

16. The method of claim 15 further comprising:
designing a vehicle panel to receive assembled components in accessory dedicated areas and fasteners in fastener dedicated areas;
identifying interstitial areas spaced from the accessory dedicated areas and the fastener dedicated areas; and
designing the vehicle panel to include raised regular geometric shaped surface features and recessed regular geometric shaped surfaces in the interstitial areas that are spaced from the accessory dedicated areas and the fastener dedicated areas.

17. The method of claim 15 wherein the raised and recessed surface features are circular domes.

18. The method of claim 15 wherein the raised and recessed surface features are polygonal raised areas and polygonal recessed areas.

19. The method of claim 15 wherein a first set of the raised and recessed surface features are a first size and a second set of the surface features are provided in a second size that is smaller than the first size.
